(19) United States
(12) Patent Application Publication
(10) Pub. No.: US 2012/0200754 A1
(43) Pub. Date: Aug. 9, 2012

(54) Image Noise Reducing Systems And Methods Thereof

(75) Inventors: Eugene Fainstain, Netanya (IL); Evgeny Artyomov, Rehovot (IL); Timofei Uvarov, Moscow (RU)

(73) Assignee: SAMSUNG ELECTRONICS CO., LTD., Suwon-si (KR)

(21) Appl. No.: 13/023,904

(22) Filed: Feb. 9, 2011

(51) Int. Cl. H04N 5/335

(52) U.S. Cl. 348/302; 348/E05.091

(57) ABSTRACT

At least one example embodiment provides for a noise reducing system for an image sensor having a pixel array, the noise reducing system includes a pattern matcher configured to receive a first pixel value of a first pixel in the pixel array and output a reduced noise pixel value of the first pixel based on a comparison of a pixel value pattern including the first pixel value and at least another pixel value pattern in the pixel array.

### BACKGROUND

### Description of Conventional Art

Digital Still Cameras (DSC) produce signals that are distorted by various fixed patterns and random noises (pixel noise).

Conventional techniques for reducing pixel noise are based on averaging signals of neighboring pixels (spatial window). This technique is based on an assumption that in the immediate local environment of the pixel to be denoised, the image is assumed to be approximately constant or can be approximated by a plane. This assumption does not hold for large windows and, therefore, limits the applicability of the conventional denoising algorithms to small windows. Small windows mean that only high-frequency noise can be reduced; for low-frequency noise reduction, wider windows are needed.

Arising from the assumption of the image being approximately constant over the local window in the pixel neighborhood is the fine textures cannot be distinguished from noise and therefore smoothed.

A block-matching noise reduction algorithm is based on a different assumption, that is, the local pixel environment repeats itself in space. This assumption holds for fine and coarse textures and edges as well. The denoising window of the algorithm, based on the block-matching technique, is not limited by the assumption of signal constancy in the small pixel neighborhood, and the window may include even the entire image. However, straightforward implementation of the block matching algorithm in red (R), green (G), blue (B) or YUV domain as a part of an ISP pipeline requires expensive line memories for holding all three components.

### SUMMARY

Example embodiments are directed to a hardware implementation of a pattern matching noise reduction algorithm in the Bayer domain, where a subsampled (Bayer) signal includes one component (R, G or B) of a tristimulus signal representation. Therefore, the line memories can be reduced by a factor of 3.

At least one example embodiment provides for a noise reducing system for an image sensor having a pixel array, the noise reducing system includes a pattern matcher configured to receive a first pixel value of a first pixel in the pixel array and output a reduced noise pixel value of the first pixel based on a comparison of a pixel value pattern including the first pixel value and at least another pixel value pattern in the pixel array.

At least one example embodiments is directed to an image signal processor including a noise reducing system for an image sensor having a pixel array, the noise reducing system including, a pattern matcher configured to receive a first pixel value of a first pixel in the pixel array and output a reduced noise pixel value of the first pixel based on a comparison of a pixel value pattern including the first pixel value and at least another pixel value pattern in the pixel array.

At least one example embodiment provides for a method of denoising pixels in a pixel array. The method includes receiving a first pixel in a pixel array, the first pixel being in a first pattern of the pixel array, determining matching patterns in the pixel array based on the first pattern, denoising the first pixel based on the determined matching patterns.

### BRIEF DESCRIPTION OF THE DRAWINGS

Example embodiments will become more apparent and readily appreciated from the following description of the drawings in which:

FIG. 1 illustrates an image sensor according to an example embodiment;

FIGS. 2A and 2B are more detailed illustrations of image sensors according to other example embodiments;

FIG. 3 is a block diagram illustrating a digital imaging system according to an example embodiment;

FIG. 4 illustrates a denoising system according to example embodiments;

FIG. 5A illustrates example pixels arranged in a Bayer pattern according to an example embodiment;

FIG. 5B illustrates a function used to derive a resulting slope from the detected slope according to an example embodiment;

FIGS. 6A-6C illustrate patterns for green pattern matching according to example embodiments;

FIGS. 7A-7B illustrate an example of green pattern matching according to an example embodiment;

FIG. 8A illustrates the pattern matching for each clock cycle;

FIG. 8B illustrates an example of a transfer function from grade to weight;

FIG. 9 illustrates an example of a V pixel pattern;

FIG. 10 illustrates an example embodiment of zero padding;

FIG. 11 illustrates an example embodiment of reducing power and a number of calculations; and

FIG. 12 illustrates a method of reducing noise in an image according to an example embodiment.

### DETAILED DESCRIPTION

Example embodiments will now be described more fully with reference to the accompanying drawings. Many alternate forms may be embodied and example embodiments should not be construed as limited to example embodiments set forth herein.

It will be understood that, although the terms first, second, etc. may be used herein to describe various elements, these elements should not be limited by these terms. These teams are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Example embodiments relate to image sensors and methods of operating the same. Example embodiments will be described herein with reference to complimentary metal oxide semiconductor (CMOS) image sensors (CIS); however, those skilled in the art will appreciate that example embodiments are applicable to other types of image sensors.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As will be described in more detail below, example embodiments may be implemented in conjunction with a gray code counter (GCC) and/or a per-column binary counter. As discussed herein, example embodiments may be implemented as a double data rate (DDR) counter. In another example, a per-column implementation may perform bit-wise inversion for correlated double sampling (CDS) addition and subtraction.

In example embodiments high and low logic states may be referred to as one and zero, respectively, but should not be limited thereto.

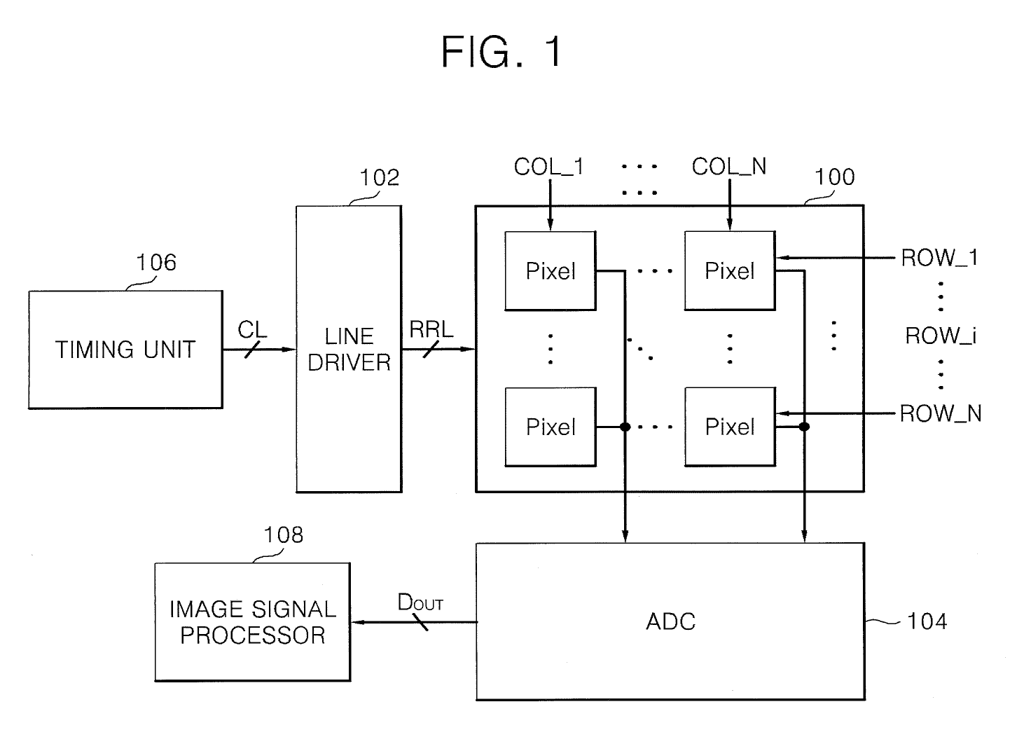

FIG. 1 illustrates an image sensor according to an example embodiment.

FIG. 1 illustrates a conventional architecture for a complementary-metal-oxide-semiconductor (CMOS) image sensor.

Referring to FIG. 1, a timing unit or circuit 106 controls a line driver 102 through one or more control lines CL. In one example, the timing unit 106 causes the line driver 102 to generate a plurality of read and reset pulses. The line driver 102 outputs the plurality of read and reset pulses to a pixel array 100 on a plurality of read and reset lines RRL.

The pixel array 100 includes a plurality of pixels P arranged in an array of rows ROW_1-ROW_N and columns COL_1-COL_N. Each of the plurality of read and reset lines RRL corresponds to a row of pixels P in the pixel array 100. In FIG. 1, each pixel P may be an active-pixel sensor (APS), and the pixel array 100 may be an APS array.

In more detail with reference to example operation of the image sensor in FIG. 1, read and reset pulses for an ith row ROW_i (where i={1, . . . , N}) of the pixel array 100 are output from the line driver 102 to the pixel array 100 via an ith of the read and reset lines RRL. In one example, the line driver 102 applies a reset signal to the ith row ROW_i of the pixel array 100 to begin an exposure period. After a given, desired or predetermined exposure time, the line driver 102 applies a read signal to the same ith row ROW_i of the pixel array to end the exposure period. The application of the read signal also initiates reading out of pixel information (e.g., exposure data) from the pixels P in the ith row ROW_i.

The analog to digital converter (ADC) 104 converts the output voltages from the ith row of readout pixels into a digital signal (or digital data). The ADC 104 may perform this conversion either serially or in parallel. An ADC 104 having a column parallel-architecture converts the output voltages into a digital signal in parallel. The ADC 104 then outputs the digital data (or digital code) DOUT to a next stage processor such as an image signal processor (ISP) 108, which processes the digital data to generate an image. In one example, the ISP 108 may also perform image processing operations on the digital data including, for example, gamma correction, auto white balancing, application of a color correction matrix (CCM), and handling chromatic aberrations.

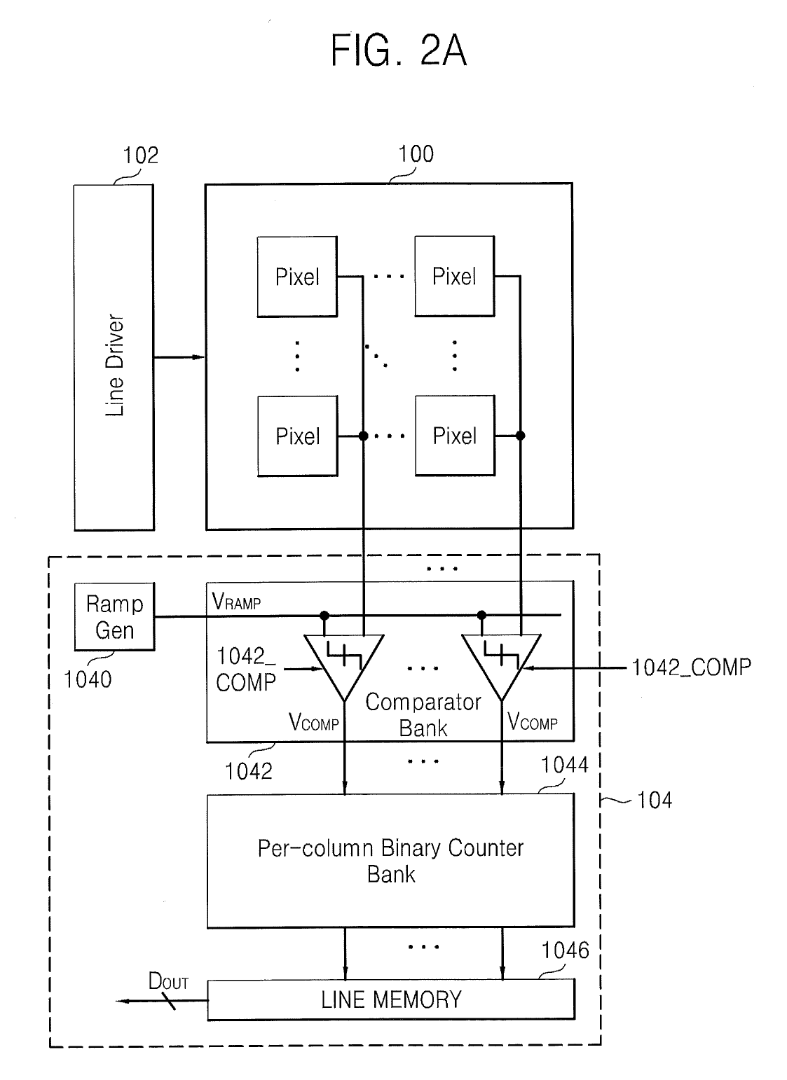

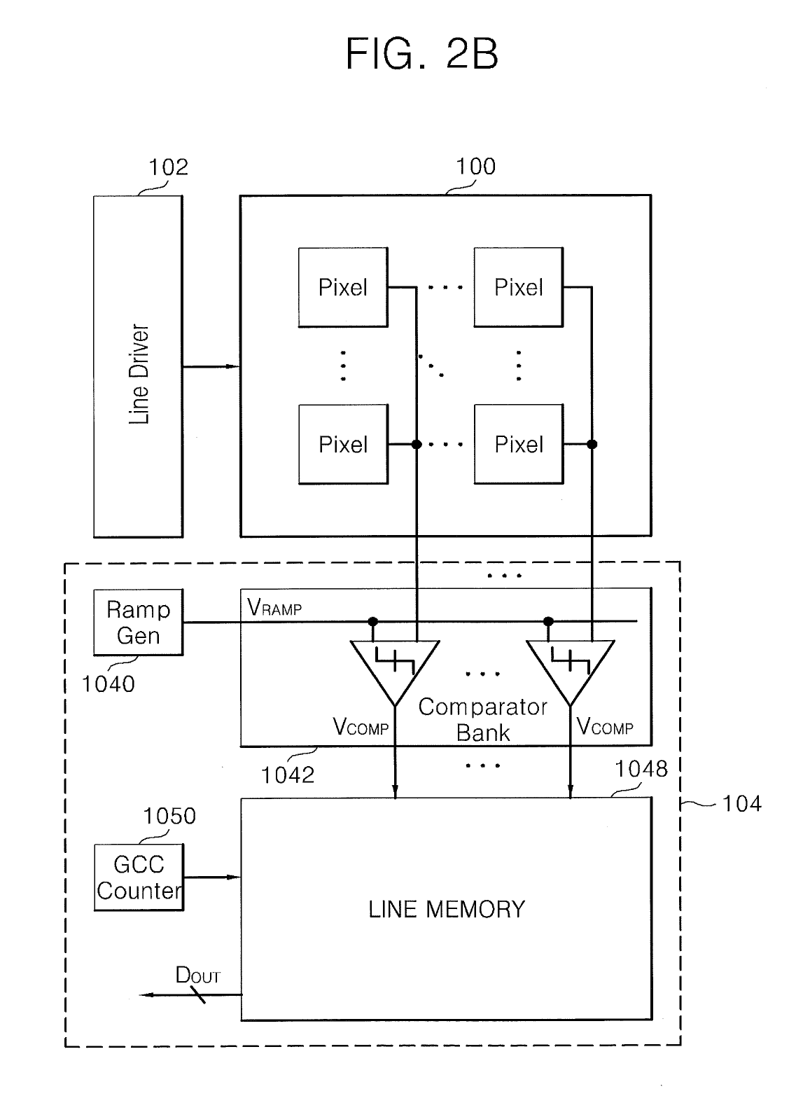

FIGS. 2A and 2B show example ADCs in more detail.

Referring to FIG. 2A, a ramp generator 1040 generates a reference voltage (or ramp signal) VRAMP and outputs the generated reference voltage VRAMP to the comparator bank 1042. The comparator bank 1042 compares the ramp signal VRAMP with each output from the pixel array 100 to generate a plurality of comparison signals VCOMP.

In more detail, the comparator bank 1042 includes a plurality of comparators 1042_COMP. Each of the plurality of comparators 1042_COMP corresponds to a column of pixels P in the pixel array 100. In example operation, each comparator 1042_COMP generates a comparison signal VCOMP by comparing the output of a corresponding pixel P to the ramp voltage VRAMP. The toggling time of the output of each comparator 1042_COMP is correlated to the pixel output voltage.

The comparator bank 1042 outputs the comparison signals VCOMP to a counter bank 1044, which converts the comparison signals VCOMP into digital output signals.

In more detail, the counter bank 1044 includes a counter for each column of the pixel array 100, and each counter converts a corresponding comparison signal VCOMP into a digital output signal. A counter of the counter bank 1044 according to example embodiments will be discussed in more detail later. The counter bank 1044 outputs the digital output signals to a line memory 1046. The digital output signals for an ith row ROW_i of the pixel array is referred to as digital data.

The line memory 1046 stores the digital data from the counter bank 1044 while output voltages for a new row of pixels are converted into digital output signals.

Referring to FIG. 2B, in this example the comparator 1042 outputs the comparison signals VCOMP to the line memory 1048 as opposed to the binary counter bank 1044 shown in FIG. 2A. Otherwise, the ramp generator 1040 and the comparator bank 1042 are the same as described above with regard to FIG. 2A.

A gray code counter (GCC) 1050 is coupled to the line memory 1048. In this example, the GCC 1050 generates a sequentially changing gray code.

The line memory 1048 stores the sequentially changing gray code from the GCC 1050 at a certain time point based on the comparison signals VCOMP received from the comparator bank 1042. The stored gray code represents the intensity of light received at the pixel or pixels.

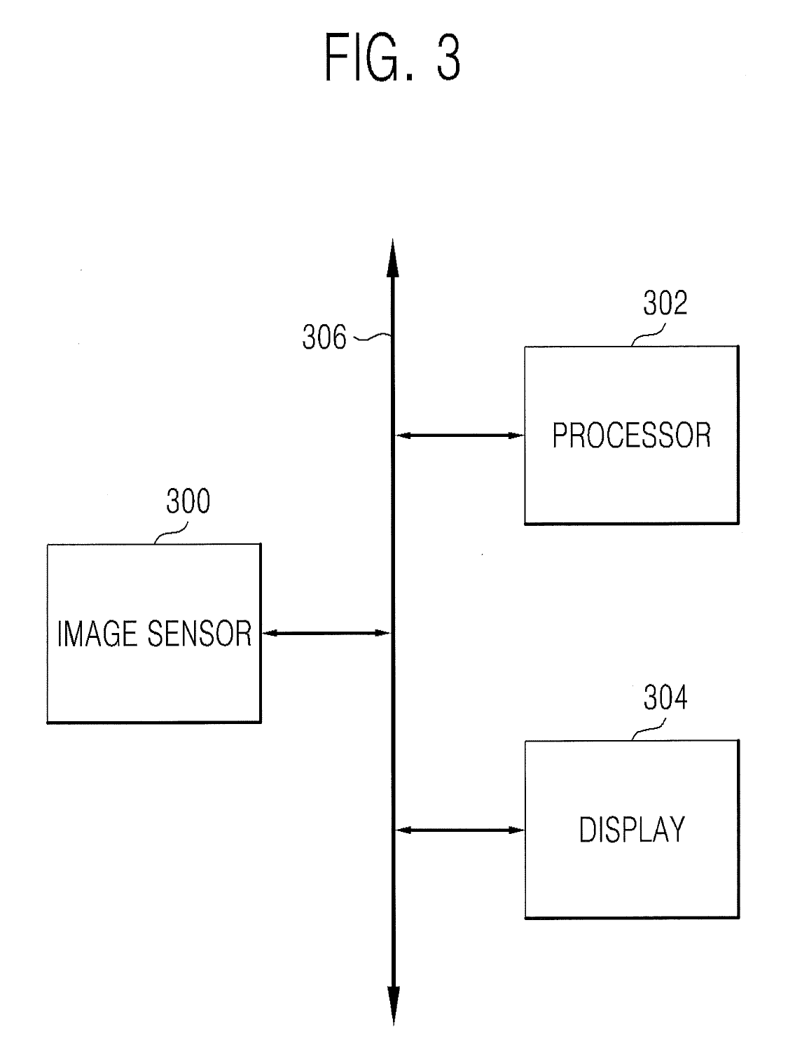

FIG. 3 is a block diagram illustrating a digital imaging system according to an example embodiment.

Referring to FIG. 3, a processor 302, an image sensor 300, and a display 304 communicate with each other via a bus 306. The processor 302 is configured to execute a program and control the digital imaging system. The image sensor 300 is configured to capture image data by converting optical images into electrical signals. The image sensor 300 may be an image sensor as described above with regard to FIG. 1, 2A or 2B. The processor 302 may include the image signal processor 108 shown in FIG. 1, and may be configured to process the captured image data for storage in a memory (not shown) and/or display by the display unit 304. The digital imaging system may be connected to an external device (e.g., a personal computer or a network) through an input/output device (not shown) and may exchange data with the external device.

For example, the digital imaging system shown in FIG. 3 may embody various electronic control systems including an image sensor (e.g., a digital camera), and may be used in, for example, mobile phones, personal digital assistants (PDAs), laptop computers, netbooks, tablet computers, MP3 players, navigation devices, household appliances, or any other device utilizing an image sensor or similar device.

Referring back to FIGS. 2A and 2B, in either architecture the counter 1044/1050 begins running when the ramp signal VRAMP starts falling. When the output VCOMP of a comparator 1042_COMP toggles, the ramp code for the corresponding pixel is (VSTART-VIN), where VSTART is the start voltage of the ramp signal VRAMP and VIN is the voltage input to the comparator 1042_COMP from the pixel array 100. The resultant digital output code DOUT is stored in the line buffer (for each column separately) and read out by an image signal processor.

Example embodiments are directed to a hardware implementation of a pattern matching noise reduction algorithm in the Bayer domain, where a subsampled (Bayer) signal includes one component (R, G or B) of a tristimulus signal representation. Therefore, the line memories can be reduced by a factor of 3. The hardware implemented algorithm may be integrated together with an image sensor on the same chip, as part of a separate logic, or as part of a general processing unit.

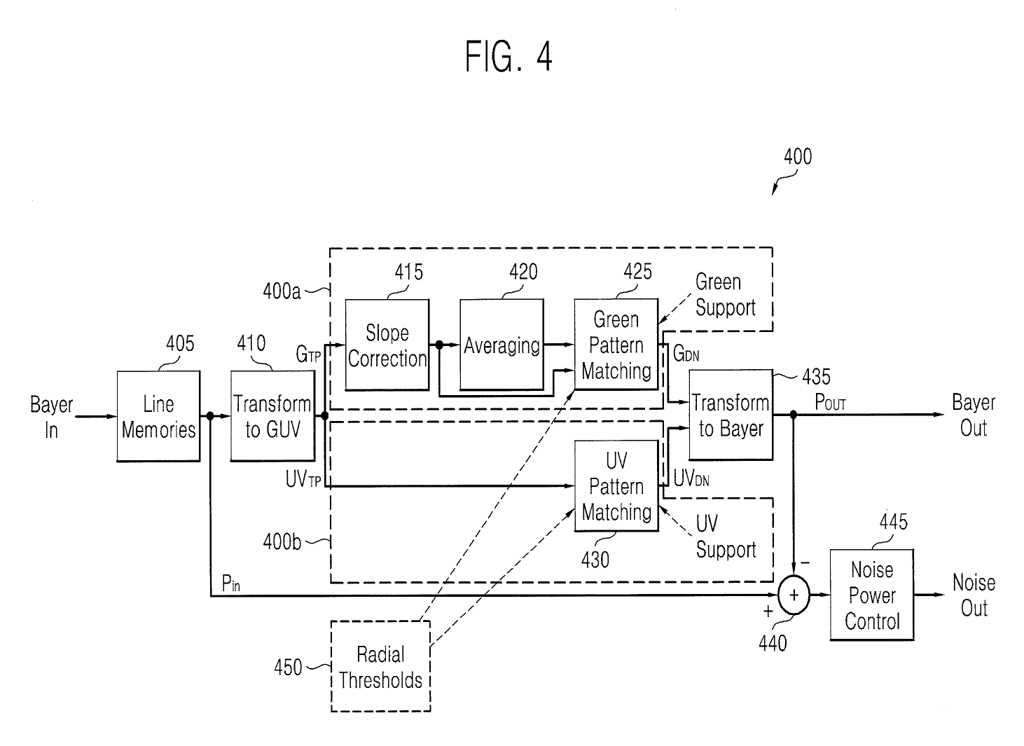

FIG. 4 illustrates a denoising system according to example embodiments. For example, a denoising system 400 may be implemented in the image signal processor 108 shown in FIG. 1. However, the denoising system 400 should not be limited to being implemented in the image signal processor 108. The denoising system 400 includes line memories 405, a Bayer to GUV transformer 410, a green processing system 400a, a UV processing system 400b, a GUV to Bayer transformer 435, an adder 440, a noise power control 445 and a radial threshold adaptor 450. The green processing system 400a includes a slope corrector 415, an averager 420 and a green pattern matcher 425. The UV processing system 400b includes a UV pattern matcher 430.

As shown, Bayer data Pᵢₙ is input to line memories 405 producing an N×N matrix. As is known, in a Bayer pattern layout, each pixel contains information that is relative to only one color component, for example, Red, Green or Blue. Generally the Bayer pattern includes a green pixel in every other space and, in each row, either a blue or a red pixel occupies the remaining spaces. To obtain a color image from a typical image sensor, a color filter (e.g., Bayer filter) is place over sensitive elements of the sensor (e.g., pixel). The individual sensors are only receptive to a particular color of light, red, blue or green. The final color picture is obtained by using a color interpolation algorithm that joins together the information provided by the differently colored adjacent pixels.

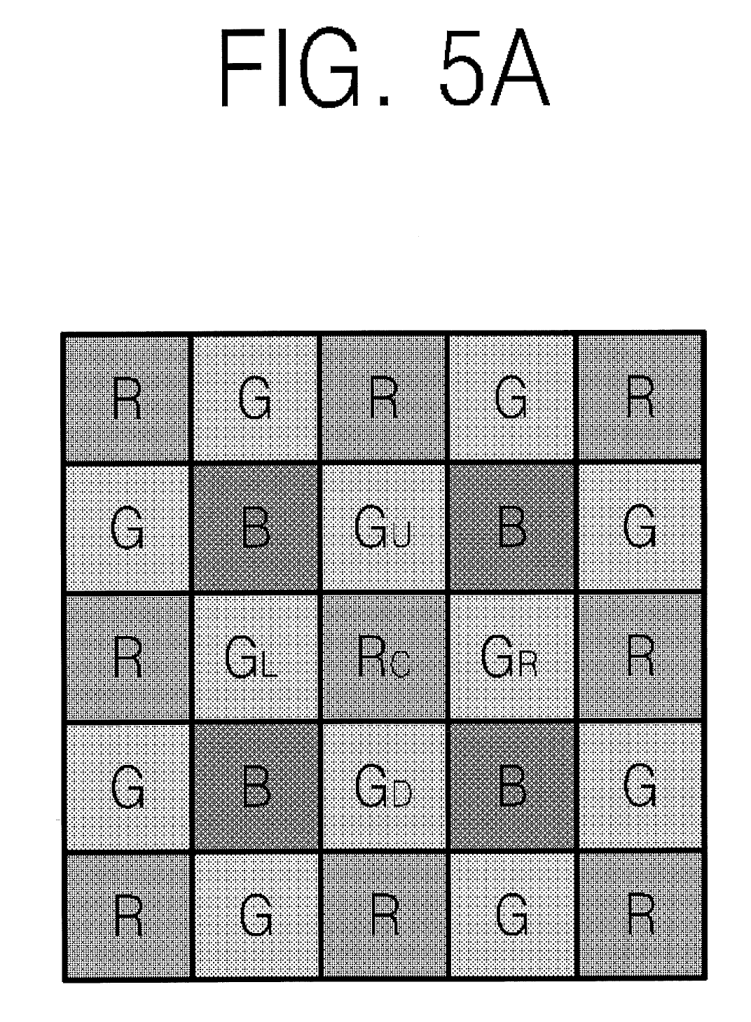

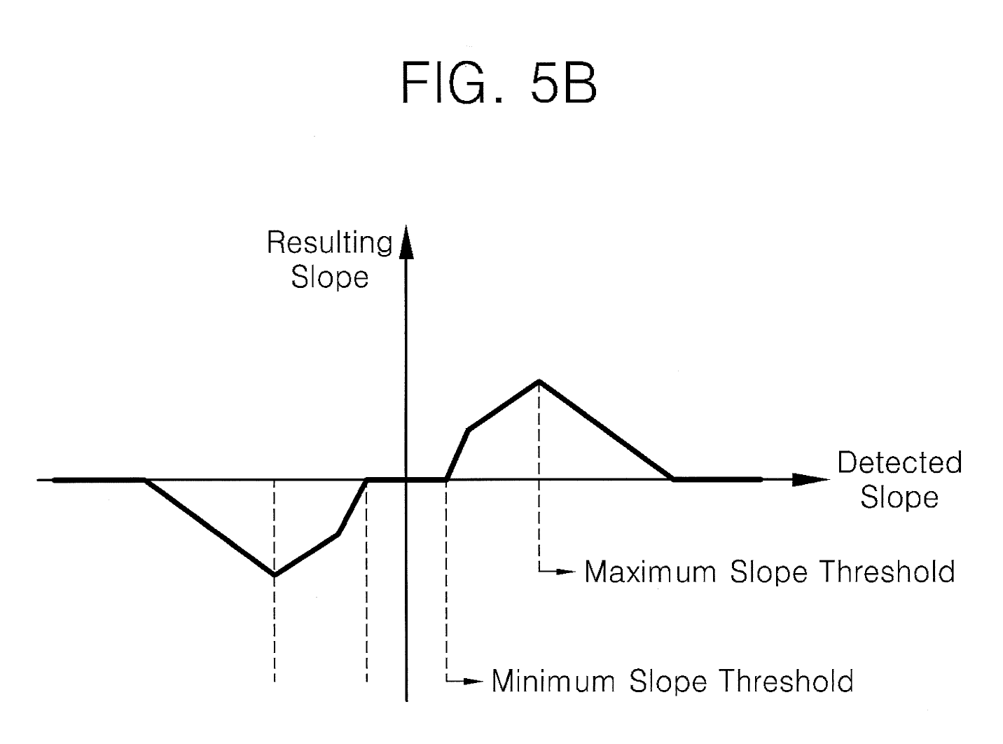

FIG. 5A illustrates example pixels arranged in a Bayer pattern according to an example embodiment. As shown, green pixels G_{Ure}, G_{Rre}, G_{Dre} and G_{Lre} are arranged at sides of a red center pixel R_{C}. U, R, D and L are used to designate up, right, down and left with respect to a center pixel designated by C. As will be described below, a center pixel may be a pixel being denoised. “Re” is used to designate the color of the pixel is red. Thus, for a blue pixel, “bl” is used to designate that a green pixel in relation to a blue pixel. It should be understood that a blue pixel B₁ may be surrounded by four green pixels, similar to the red center pixel R_{C}.

Referring back to FIG. 4, once the Bayer data Pᵢₙ is received, the Bayer to GUV transformer 410 transforms the Bayer data Pᵢₙ from the RGB Bayer domain into the GUV domain. The U and V components are calculated as follows:

U_{C}=R_{C}−median(G_{Ure},G_{Dre},G_{Lre},G_{Rre}) (1)

V_{C}=B_{C}−median(G_{Ubl},G_{Dbl},G_{Lbl},G_{Rbl}) (2)

wherein B_{C} is a center blue pixel and G_{Ubl}, G_{Dbl}, G_{Lbl}, G_{Rbl} are green pixels arranged at sides of the blue center pixel B_{C}. The GUV is understood by one of ordinary skill, thus, a description of the GUV domain will be omitted. Furthermore, while example embodiments are described with reference to Bayer and GUV data, it should be understood that example embodiments may be implemented in various known domains. For example, example embodiments may be implemented in just RGB (Bayer domain) without a transformation to GUV or may be transformed into Lab or YUV. It should be understood that example embodiments are not limited to RGB.

A matrix of green pixel values G_{TP} is input from the transformer 410 to the green processing system 400a and a matrix of the UV pixel values UV_{TP} is input from the transformer 410 to the UV processing system 400b. The green pixel values G_{TP} and the UV pixel values UV_{TP} may be separated using any known means. The matrices of the green pixel values G_{TP} and the UV pixel values UV_{TP} may be M×M, where M is greater than one. It should be understood that he matrices of the green pixel values G_{TP} and the UV pixel values UV_{TP}. may be may be different sizes and are not limited to square matrices.

The slope corrector 415 is configured to receive the green pixel values G_{TP} output from the Bayer to GUV transformer 410. More specifically, the slope corrector 415 removes the slope of the signal that includes the green pixel values G_{TP}. The slope corrector 415 may estimate the slope using linear regression. The green pixel values G_{TP} in the M×M matrix are summed in the horizontal and vertical directions to produce two vectors (one based on the horizontal direction and one based on the vertical direction). Linear regression is applied to the two vectors separately. A slope corrected signal results from summing the processed vectors.

For example, vertical sums Vᵢ[1,M] and horizontal sums Hᵢ[1,M] are computed. Linear regression is then applied to the vertical sums and the horizontal sums. For example, linear regression for the vertical sums Vᵢ is:

$$Δ x = \frac{{\sum }_{i = 1}^{12} ( {V}_{i} - {V}_{- i} ) ( i )}{{\sum }_{i = 1}^{12} {i}^{2}} * 2 \qquad ( 3 )$$

Linear regression is applied to the horizontal sums in the same manner. The result is two values Δx and Δy (linear regression of horizontal sums), where Δx and Δy are detected slopes.

FIG. 5B illustrates a function used to derive a resulting slope from the detected slope according to an example embodiment. The function shown in FIG. 5B is used to limit slopes. For example, for large detected slopes (slopes that exceed a maximum slope threshold), correction declines slowly. The resulting slope of the function shown in FIG. 5B does not fall instantly to zero after exceeding a maximum slope to reduce undesirable artifacts. The same is for small detected slope (slopes below a minimum slope threshold) because a small detected slope may be due to some kind of noise. The maximum slope threshold and minimum slope threshold may be adjusted by a radial function. In the example described above, the max value is 12 meaning that the M×M matrix is 12×12.

The slope corrector 415 is configured to output the slope corrected signal of the green pixel values G_{TP}.

The output from the slope corrector 415 is input to the averager 420 and the green pattern matcher 425. The averager 420 smoothes the slope corrected green pixel values before green pattern matching.

The averager 420 receives a matrix of M×M slope corrected green pixel values representing the green pixels. All of the green pixels are averaged using closest neighbors. In GUV, each green pixel has four neighbors. Each green pixel is averaged by adding green pixel values of the four neighbors and multiplying the sum by a neighbor weight to result in a weighted neighbor value. The weighted neighbor value is then added to a product of a central weight times the green pixel value of the green pixel being averaged. The result is an averaged green pixel value. If a green pixel is on the border, the values of the neighbors are multiplied so that the green pixel has four neighbor values. For example, if a green pixel only has two neighbors, the values of each neighbor are multiplied by two.

Alternatively, it should be understood that the neighbor values and the green pixel value being averaged do not need to be weighted.

Once the green pixels are averaged, the averager 420 outputs the averaged green pixel matrix to the green pattern matcher 425 where green pattern matching is performed by the green pattern matcher 425. The green pattern matcher 425 performs the green pattern matching based on the averaged green pixel values, the slope corrected green pixel values received from the slope corrector 415 and radial thresholds. The pattern matching is based on a parameter Green Support, which sets the support for pattern matching. Only pixels inside the support used. For example, if Green Support is 6, then only pixels within 6 rows and/or columns of a pixel being denoised. Pattern matching is described in further detail below.

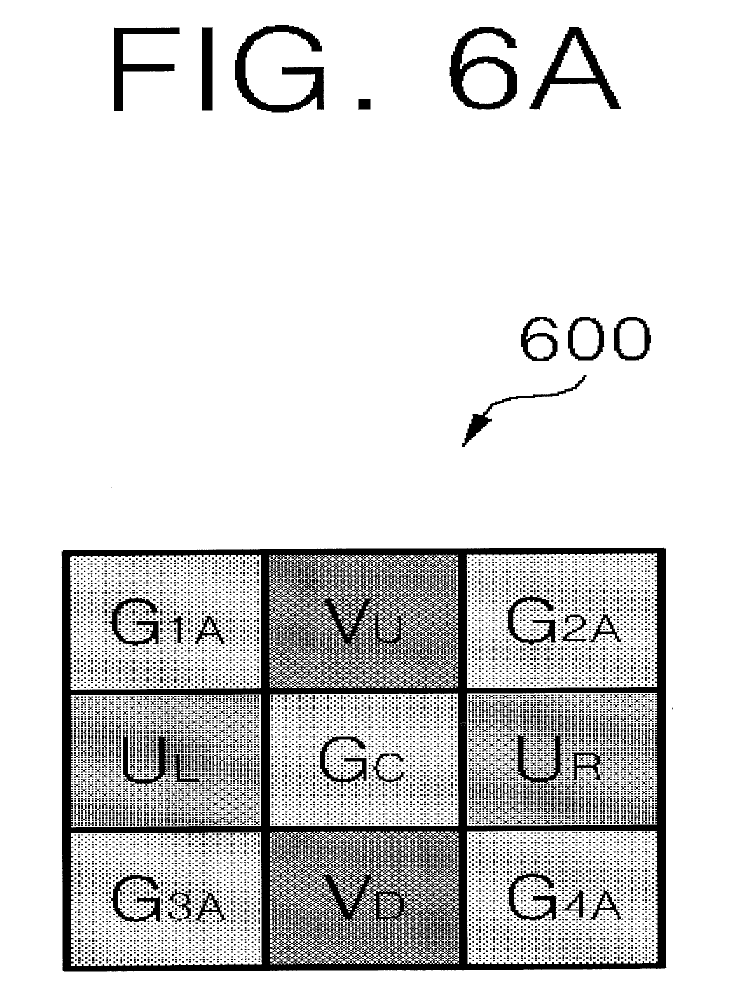

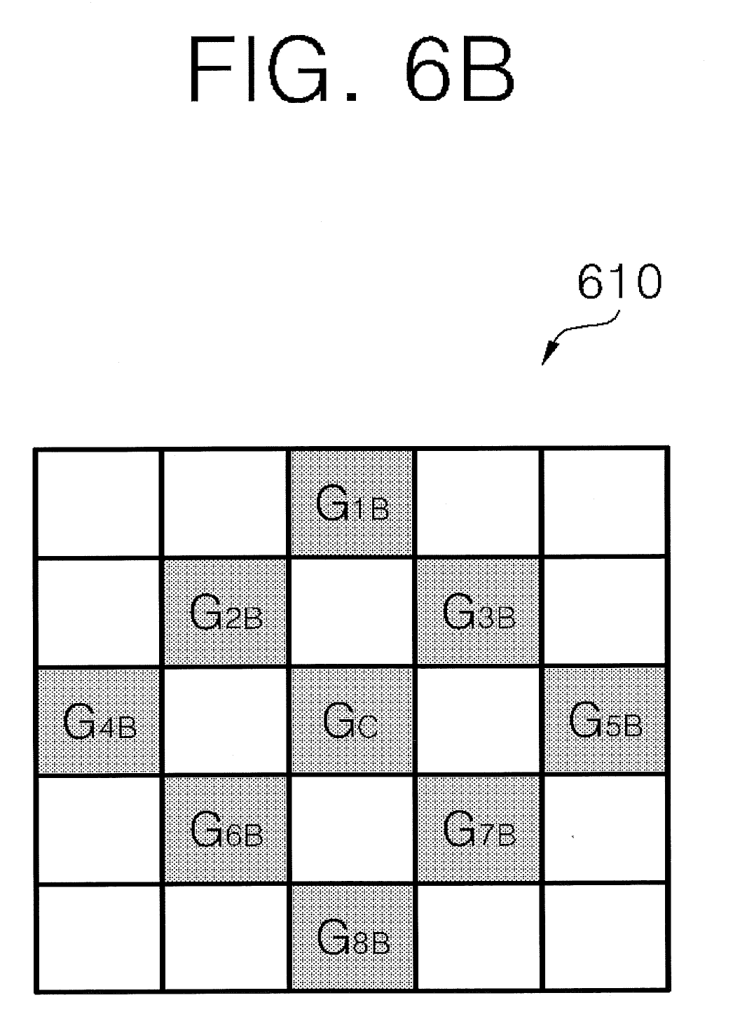

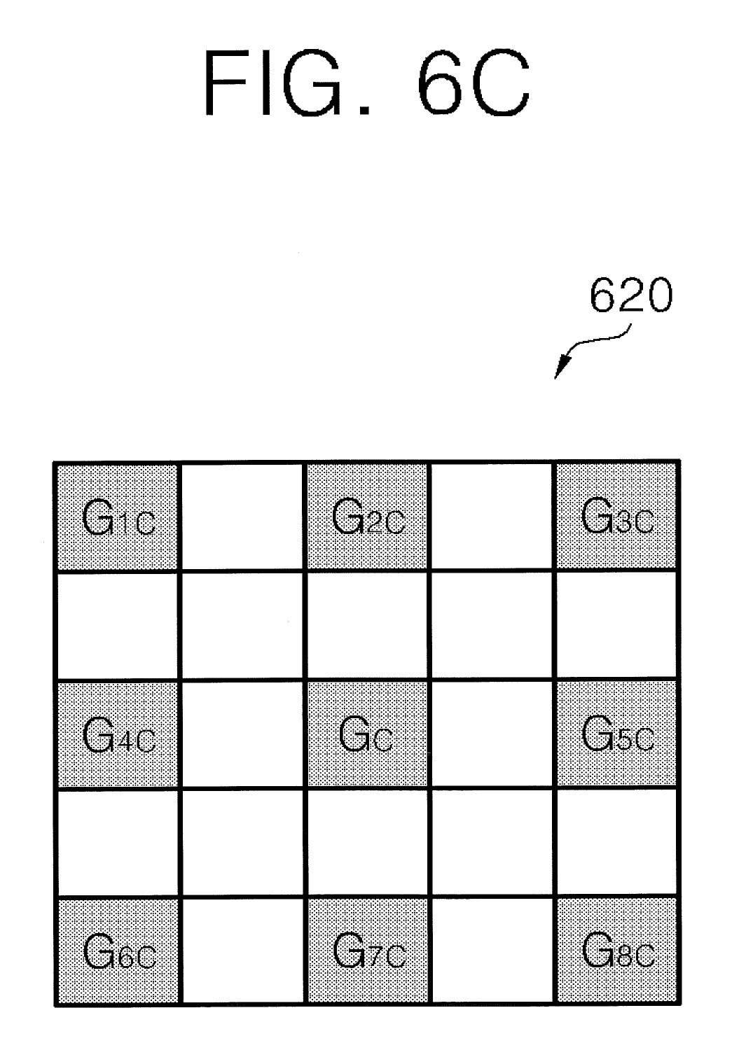

FIGS. 6A-6C illustrate green pixel patterns for green pattern matching areas according to example embodiments. In more detail, FIGS. 6A-6C illustrate various green pixel patterns an image sensor may include. The various patterns may be chosen by the denoising system 400 based on the noise. In FIG. 6A, green pixels G_{1A}-G_{4A} and G_{C} may be used in a green pixel pattern 600. In normal illumination conditions, UV pixels V_{U}, V_{D}, U_{R} and U_{L} may be included in the green pattern matching. In high noise conditions, a green pixel pattern 610 in FIG. 6B or a green pixel pattern 620 in FIG. 6C may be used.

Since noise performs signal masking, the lower the noise, the smaller the pattern matching area that is used. For high noise, fine details masked by high noise may be missed with a small pattern matching area. To recover details in high noise, larger pattern matching areas are used. The noise is based on an illumination condition. In low illumination conditions, the noise is higher. The noise may be measured as a standard deviation of pixel values in a pixel array.

It should be understood, that example embodiments are not limited to the green pixel patterns shown in FIGS. 6A-6C and other green pixel patterns may be used.

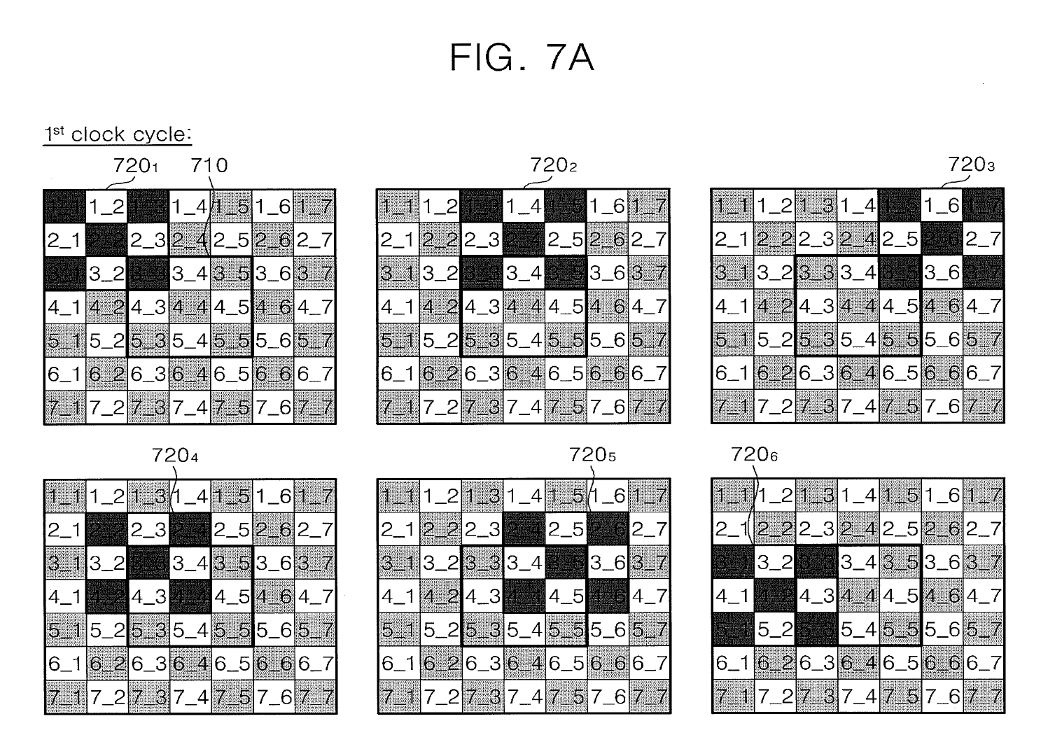

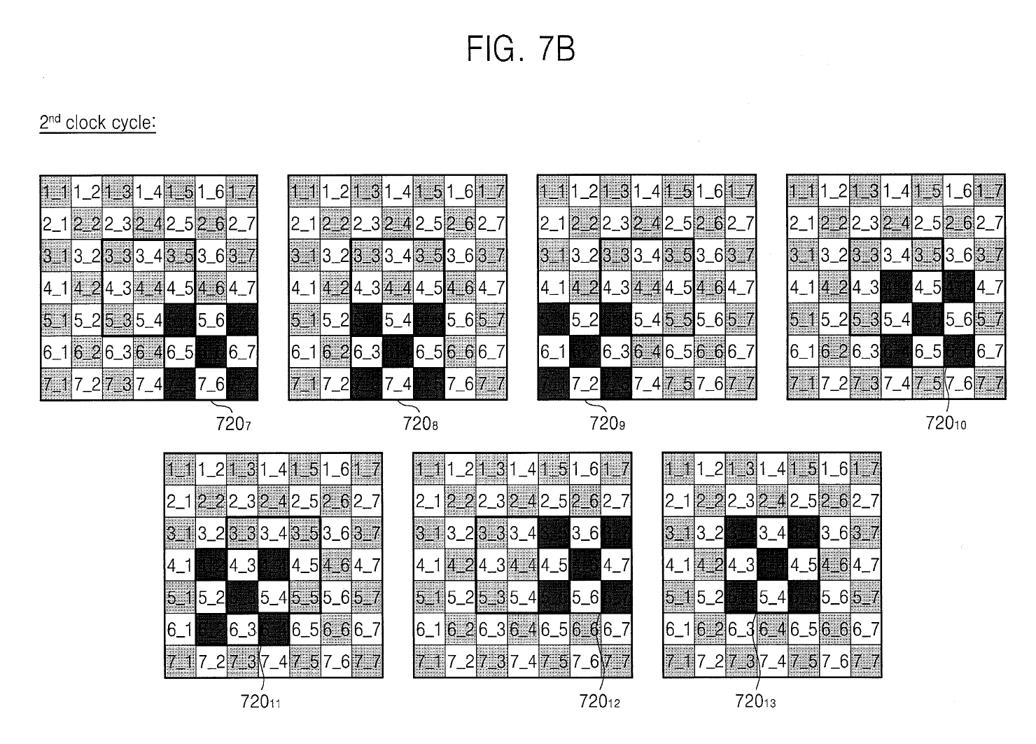

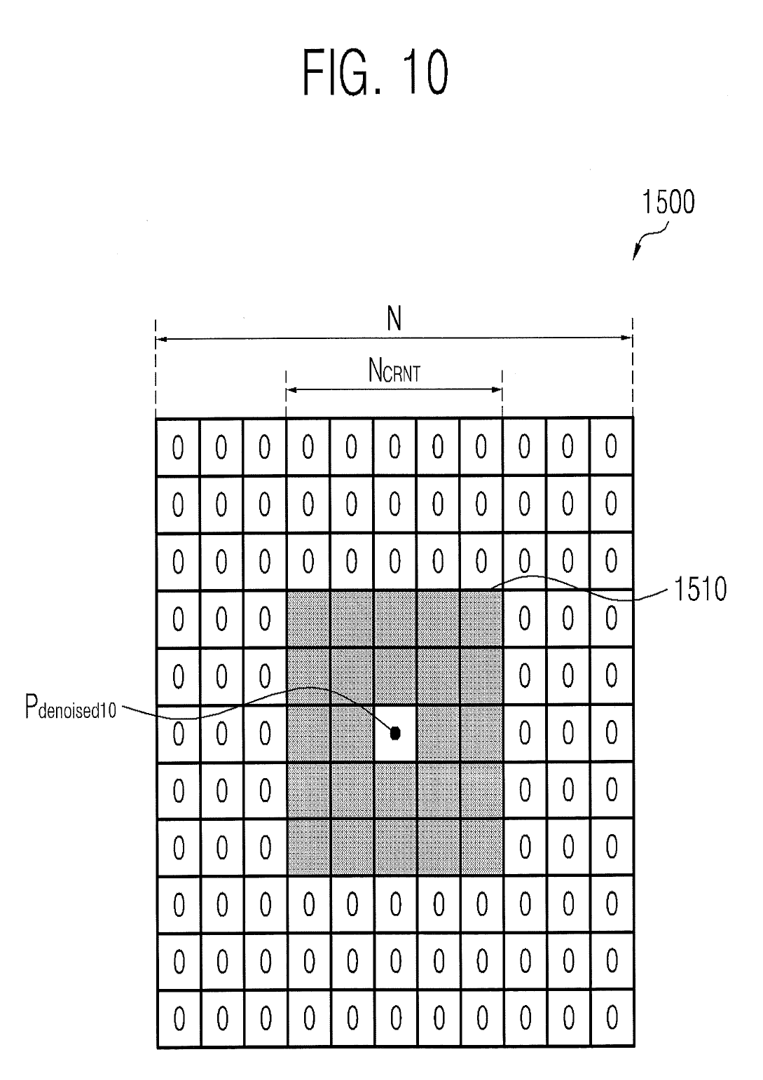

FIGS. 7A-7B illustrate an example of green pattern matching according to an example embodiment. As shown, an area of a pixel array includes green pixels 1_1, 1_3, 1_5, 1_7, 2_2, 2_4, 2_6, 3_1, 3_3, 3_5, 3_7, 4_2, 4_4, 4_6, 5_1, 5_3, 5_5, 5_7, 6_2, 6_4, 6_6, 7_1, 7_3, 7_5, and 7_7. Here, the green pixel pattern of FIG. 6A (without UV pixels) is used for pattern matching. The pixel undergoing denoising is the center pixel 4_4 of a green pixel pattern area 710. It should be understood, that the pixel undergoing denoising is the pixel at the center of the pattern being matched (the green pixel pattern area 710). When the area used for a pattern matching search area is less than the size of the pixel array, zero padding is used as will be described with reference to FIG. 10.

As discussed above, the pattern matching search area can be controlled by the denoising system 400. Thus, for good illumination situations, the pattern matching search area may be reduced. Reduction of the search area enables better detail preservation since fewer pixels will be included.

As shown, the center pixel 4_4 undergoing denoising is the center pixel of the green pixel pattern area being matched 710. As shown in FIGS. 7A-7B, the pattern matching may be performed in parallel in two cycles. In other words, half of the pattern matches are done simultaneously at one clock and another half on the next clock. For example, pattern matching areas 720₁-720₆ are compared to the green pixel pattern area being matched 710 in the first clock cycle and pattern matching areas 720₇-720₁₃ are compared to the green pixel pattern area being matched 710 in the second clock cycle.

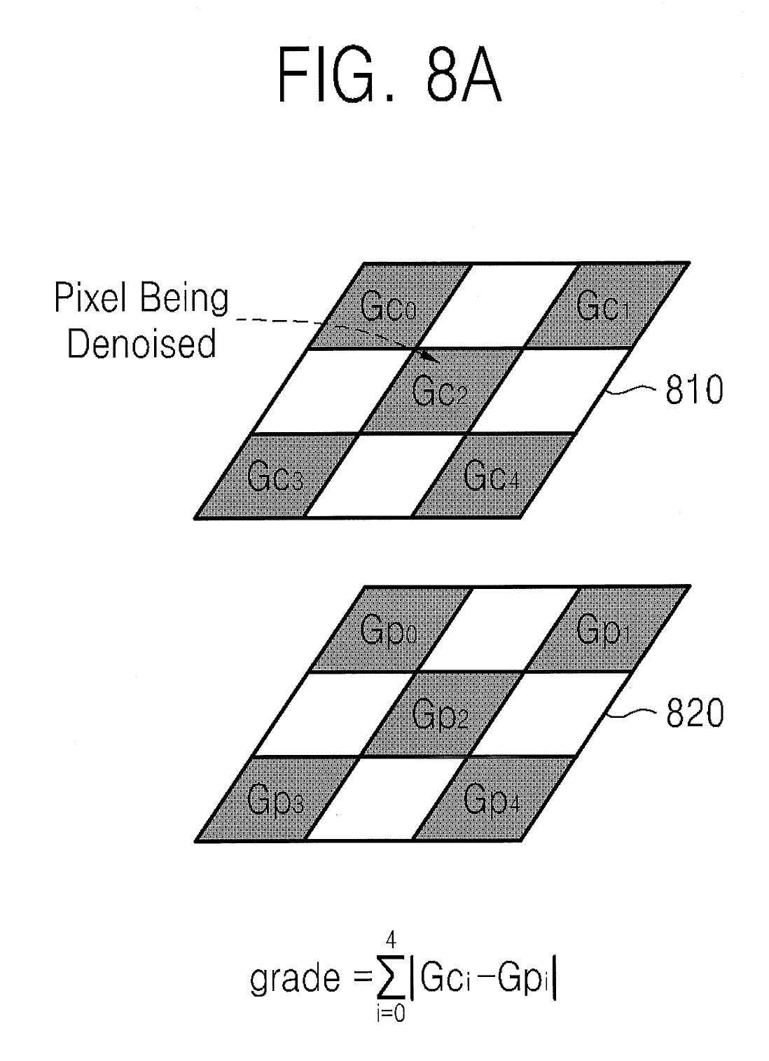

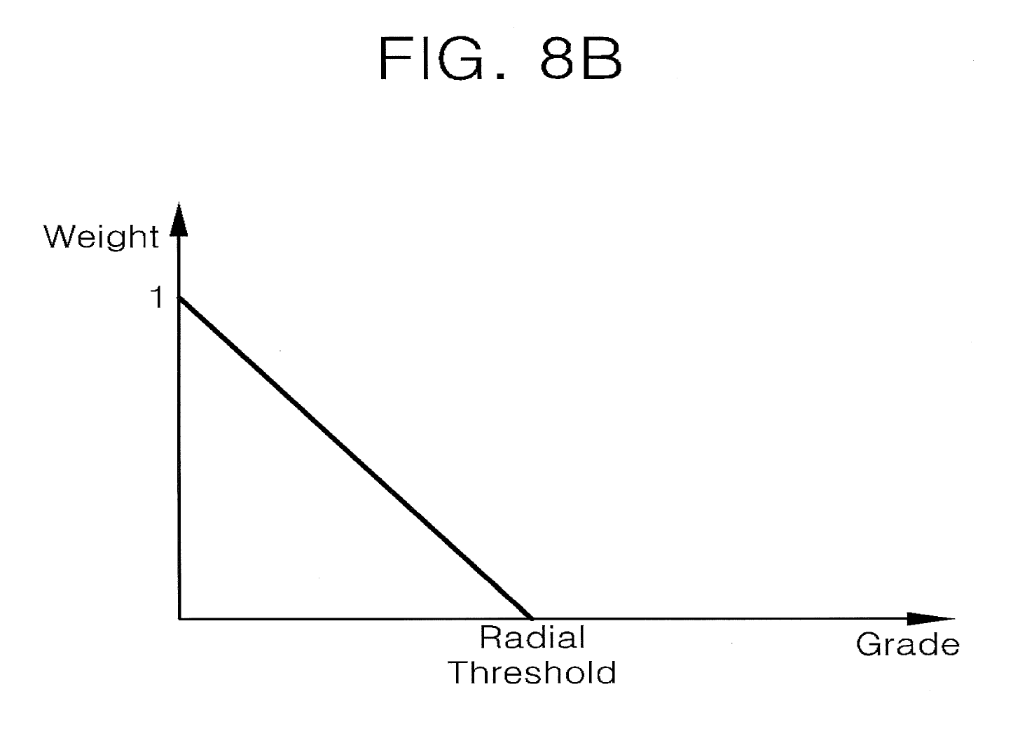

FIG. 8A illustrates the pattern matching principle. As shown, the green pixel pattern matching is based on a Sum of Absolute Differences (SAD) between a green pixel pattern of a green pixel undergoing denoising G_{C2} and green pixel pattern areas of nearby pixels.

In FIG. 8A, the pixel being denoised G_{C2} may correspond to the pixel 4_4 in FIGS. 7A-7B. A pattern matching area 820 may correspond to any one of the pattern matching areas 720₁-720₁₃ shown in FIGS. 7A-7B, based on the clock cycle. As shown, during pattern matching, each green pixel in a green pixel pattern area being matched 810 (e.g., G_{C0}-G_{C4}) is compared to a green pixel in a matching green pixel pattern area 820 that is in the same location of the green pixel pattern. The sum of the comparisons results in a grade for the pattern matching. More specifically, the green pattern matcher 425 determines a grade for a cycle of pattern matching as follows:

$$G = {\sum }_{i = 0}^{n} \vert {G}_{Ci} - {G}_{pi} \vert \qquad ( 4 )$$

wherein n is the number of green pixels being compared, G is the grade, G_{Ci} is the green pixel value for the green pixel pattern area being matched 810 and G_{Pi} is the green pixel value for the matching green pixel pattern area 820.

After the grade G is found, the grade is transferred to a weight. An example of a transfer function from grade to weight is shown in FIG. 8B. A radial threshold shown in FIG. 8B is computed based on the noise in the pixel array. The radial threshold is described in greater detail below.

To compute a denoised green pixel value G_{DN} of the green pixel being denoised, the following weighted averaging approach is used by the green pattern matcher 425:

$$NewPixel = \frac{{\sum }_{i = 1}^{N} ( {weight}_{i} \times {PixelIn}_{i} )}{{\sum }_{i = 1}^{N} {weight}_{i}} \qquad ( 5 )$$

wherein PixelInᵢ is the value of the central pixel in the pattern matching area (e.g., Gₚ₂ in FIG. 8A) and N is the number of pixels in pattern matching area.

Denoised pixel values G_{DN} are output from the green pattern matcher 425 and input to the GUV to Bayer transformer 435.

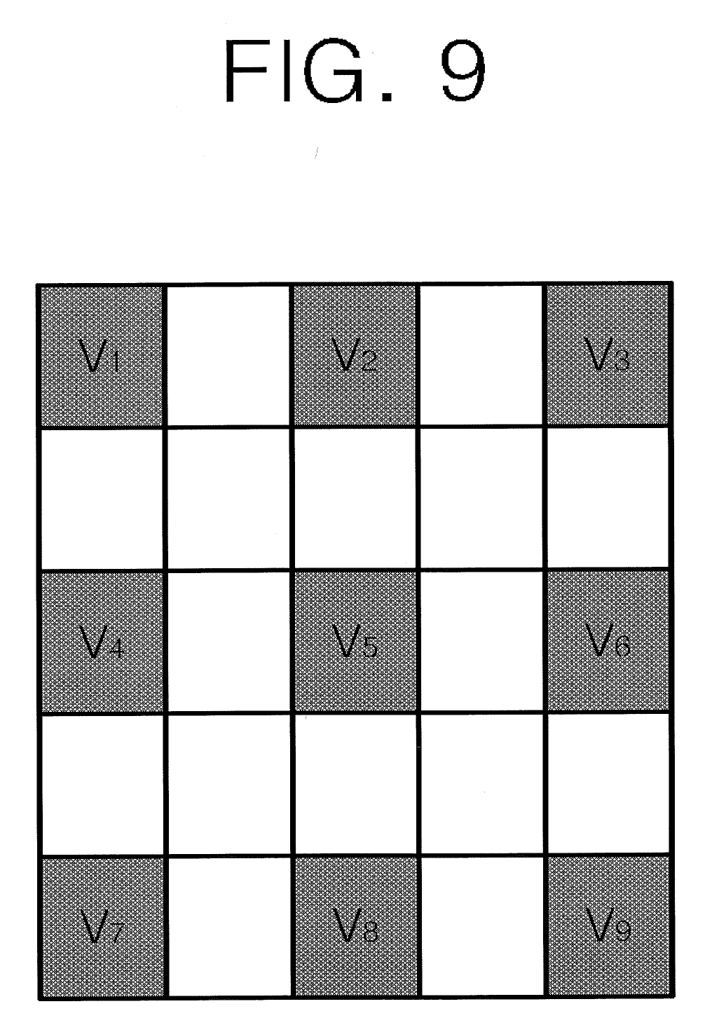

Referring to FIG. 4, the transformed UV pixel values are input to a UV pattern matcher 430. The UV pattern matcher 430 operates in the same manner as the green pattern matcher 425, except the UV pattern matcher 430 matches patterns of UV pixels. For the sake of clarity and brevity, the UV pattern matcher 430 will not be described in greater detail. An example of a V pattern is illustrated in FIG. 9. Pixels V1-V9 are arranged every other pixel at every other line.

Denoised UV pixel values UV_{DN} are output from the UV pattern matcher 430 and input to the GUV to Bayer transformer 435.

The GUV to Bayer transformer 435 is configured to receive the denoised green pixel values G_{DN} and the denoised UV pixel values UV_{DN}. The GUV to Bayer transformer 435 transforms the denoised UV pixel values UV_{DN} into the Bayer domain. The denoised green pixel values G_{DN} do not need to be transformed. The transformed pixels Pout are output from the denoising system 400. The transformed pixels Pout are also input into an adder 440 where they are added with the Bayer data Pᵢₙ. The sum from the adder 440 is input to the noise power control 445.

On edges of the image sensor, noise is higher than in the center of the image sensor. Since noise is variable based on a distance from the center of the image sensor, the noise power control 445 is configured to scale the noise using radial scaling. The noise power control 445 is configured to output a flat noise level across the image sensor by radially scaling noise.

As shown in FIG. 4, the green and UV pattern matching are based on radial thresholds. When a noise reduction block is located after a lens shading correction, the noise level radially increases. Thus, the radial threshold adaptor 450 corrects the radial threshold to allow adjustment of the radial threshold as a function of a distance the denoising pixel is from the optical center of the image sensor. The closer a denoising pixel is to the periphery of the image sensor, the higher the radial threshold. The radial thresholds for the green and UV pattern matching may be determined during sensor calibration based on empirical data and depends on the type of lens and sensor.

FIG. 10 illustrates an example embodiment of zero padding. As shown in FIG. 10, a pixel array 1500 includes a denoising area 1510 having an area N_{CRNT}×N_{CRNT}, where N_{CRNT} is less than N. An area of the pixel array 1500 is N×N. Therefore, to reduce power consumption, the green and UV pattern matchers 425 and 430 replace the pixel values outside the denoising area 1510 (around the denoised pixel P_{denoised10}) with zeros. Power is saved by reducing a number of toggling in the denoising system 400. By using zero padding, circuitry propagates a constant value that does not cause toggling of registers and logic.

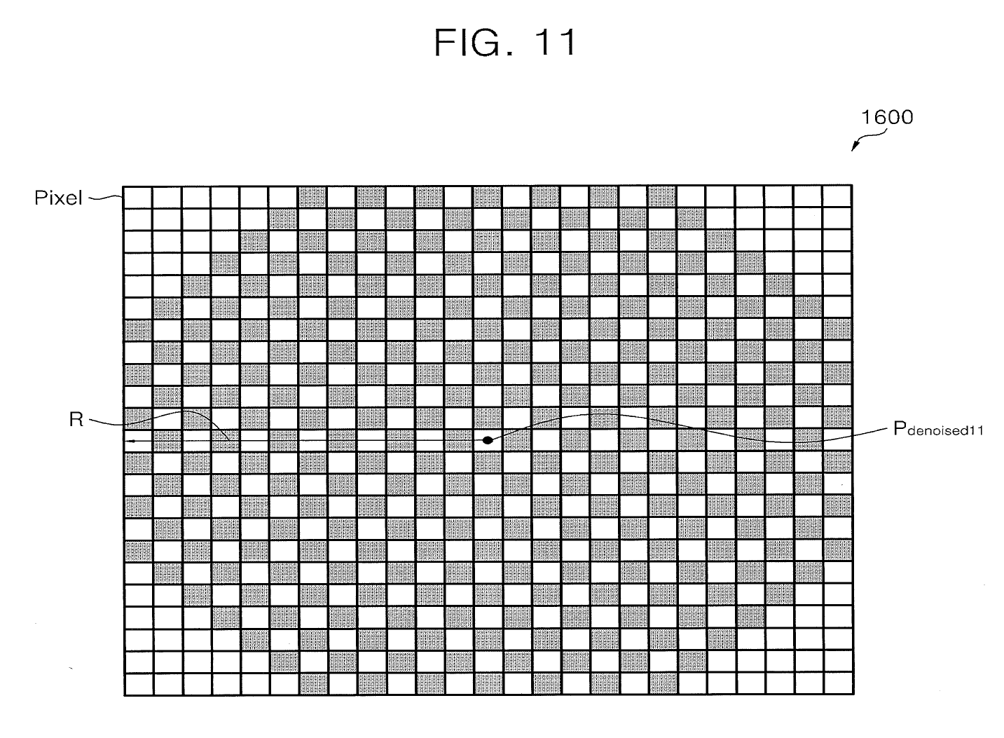

Another example embodiment of reducing power and a number of calculations when pattern matching is shown in FIG. 11. As shown in FIG. 11, a pixel array 1600 includes a plurality of pixels. To reduce the number of calculations and, thus, the number of searched patterns, the green and UV pattern matchers 425 and 430 are configured to discard pixels outside of a radius R from a denoised pixel P_{denoised11}. The radius R may be determined during calibration and based on empirical data.

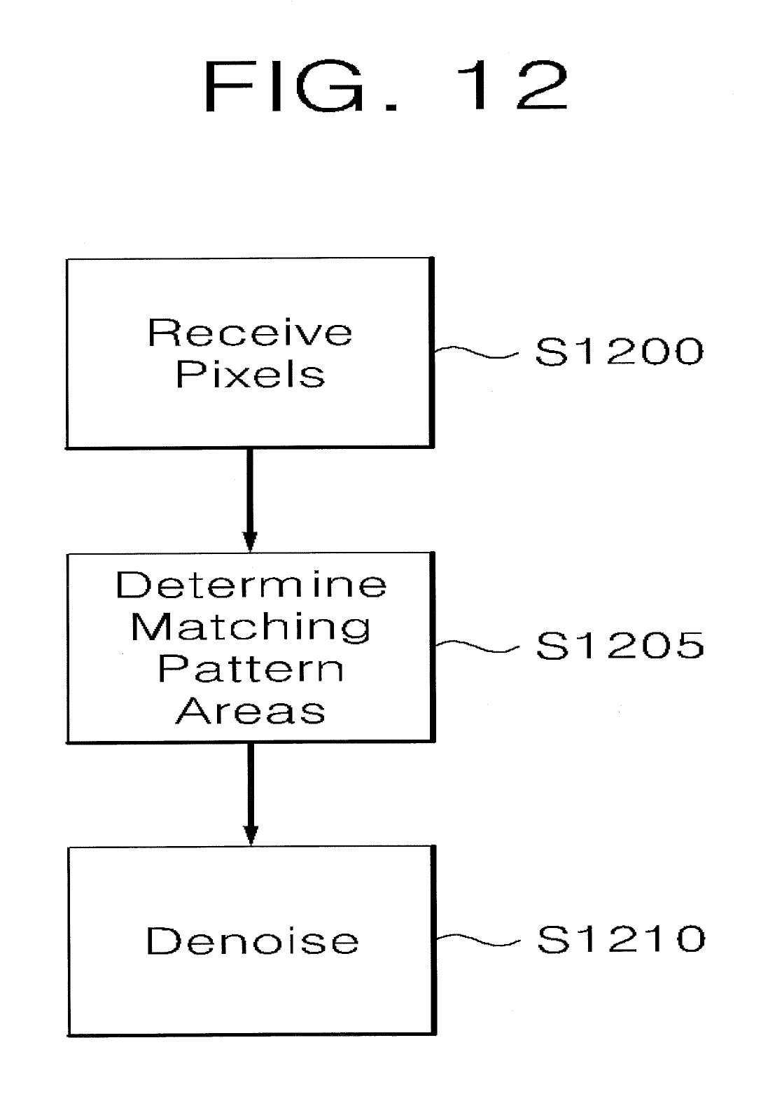

FIG. 12 illustrates a method of reducing noise in an image according to an example embodiment. The method shown in FIG. 12 may be performed by the denoising system 400. Thus, it should be understood that the functions performed by the denoising system 400 may be included in the method shown in FIG. 12.

As S1200, the denoising system receives the pixel values of pixels as Bayer data, producing an N×N matrix. The Bayer data may be transformed into GUV data by a transformer (e.g., the transformer 410).

At S1205, for each pixel being denoised, the denoising system determines matching pattern areas. The pattern matching of S1205 is the same as the pattern matching described with reference to FIGS. 4-11. Thus, for the sake of clarity and brevity a more detailed description will be omitted.

At S1210, the pixels are denoised. The denoising of S1210 is the same as the denoising described with reference to FIGS. 4-11, more specifically, FIGS. 8A-8B. Thus, for the sake of clarity and brevity a more detailed description will be omitted.

After the pixels are denoised, the UV pixel values are transformed into RB pixels (e.g., by the transformer 435).

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A noise reducing system for an image sensor having a pixel array, the noise reducing system comprising:
a pattern matcher configured to receive a first pixel value of a first pixel in the pixel array and output a reduced noise pixel value of the first pixel based on a comparison of a pixel value pattern area including the first pixel value and at least another pixel value pattern area in the pixel array.

2. The noise reducing system of claim 1, further comprising:
a transformer configured to receive the first in a first domain and transform the first pixel to the first pixel in a second domain.

3. The noise reducing system of claim 2, wherein the first domain is a Bayer domain and the second domain is a GUV domain.

4. The noise reducing system of claim 1, wherein the first pixel is in one of Bayer, RGB and YUV domains.

5. The noise reducing system of claim 1, wherein the first pixel is associated with a first color and the pixel value pattern area includes pixel values associated with the first color.

6. The noise reducing system of claim 5, wherein the pixel value pattern area includes pixel values associated with second and third colors.

7. The noise reducing system of claim 1, wherein the pattern matcher is configured to output the reduced noise pixel value of the first pixel based on a threshold, the threshold being based on a distance of the first pixel from a center of the pixel array.

8. The noise reducing system of claim 7, wherein the pattern matcher is configured to weight a result of the comparison of the pixel value pattern area including the first pixel value and the at least another pixel value pattern area in the pixel array, the weight being based on the threshold.

9. The noise reducing system of claim 8, wherein the weighted result is the reduced noise pixel value.

10. An image signal processor comprising:
a noise reducing system for an image sensor having a pixel array, the noise reducing system including,
a pattern matcher configured to receive a first pixel value of a first pixel in the pixel array and output a reduced noise pixel value of the first pixel based on a comparison of a pixel value pattern area including the first pixel value and at least another pixel value pattern area in the pixel array.

11. The image signal processor of claim 1, image signal processor includes,
a transformer configured to receive the first in a first domain and transform the first pixel to the first pixel in a second domain.

12. The image signal processor of claim 11, wherein the first domain is a Bayer domain and the second domain is a GUV domain.

13. The image signal processor of claim 1, wherein the first pixel is in one of Bayer, RGB and YUV domains.

14. The image signal processor of claim 1, wherein the first pixel is associated with a first color and the pixel value pattern area includes pixel values associated with the first color.

15. The image signal processor of claim 14, wherein the pixel value pattern includes pixel values associated with second and third colors.

16. The image signal processor of claim 1, wherein the pattern matcher is configured to output the reduced noise pixel value of the first pixel based on a threshold, the threshold being based on a distance of the first pixel from a center of the pixel array.

17. The image signal processor of claim 16, wherein the pattern matcher is configured to weight a result of the comparison of the pixel value pattern area including the first pixel value and the at least another pixel value pattern area in the pixel array, the weight being based on the threshold.

18. The image signal processor of claim 17, wherein the weighted result is the reduced noise pixel value.

19. A method of denoising pixels in a pixel array, the method comprising:
receiving a first pixel in a pixel array, the first pixel being in a first pattern of the pixel array;
determining matching pattern areas in the pixel array based on the first pattern;
denoising the first pixel based on the determined matching pattern areas.

20. The method of claim 20 wherein the denoising includes,
determining a matching pixel for each of the determined matching pattern areas, and
determining a denoised first pixel based on the matching pixels.
